(19) United States
(12) Patent Application Publication
(10) Pub. No.: US 2026/0093638 A1
(43) Pub. Date: Apr. 2, 2026

(54) SECURITY FUNCTION MANAGEMENT WITHIN A MULTI-PORT MEMORY SYSTEM

(71) Applicant: Micron Technology, Inc., Boise, ID (US)

(72) Inventors: John E. Maroney, Irvine, CA (US); Pedro Cordon, Irvine, CA (US); Henry H. Torabi, Irvine, CA (US); Robert W. Strong, El Dorado Hills, CA (US)

(21) Appl. No.: 19/339,068

(22) Filed: Sep. 24, 2025

Related U.S. Application Data
(60) Provisional application No. 63/701,288, filed on Sep. 30, 2024.

(51) Int. Cl. G06F 12/14

(52) U.S. Cl. CPC G06F 12/1466; G06F 12/145

(57) ABSTRACT

Methods, systems, and devices for security function management within a multi-port memory system are described. A memory system may include multiple ports each coupled with one or more host systems. The memory system may receive a namespace configuration indicating an allocation of one or more logical block addresses (LBAs) to one or more of the ports. The memory system may further receive one or more requests for access to one or more LBA ranges, and may perform an authorization procedure to authorize a single entity to provision and unlock corresponding LBA ranges. In some examples, LBA ranges may be locked by default on bootup of the memory system. In some cases, host systems may request a management controller to coordinate authorization, or may request authorization from a memory system directly using one or more credentials or identifiers. Further, a management port may be indicated via one or more commands.

### CROSS REFERENCE

The present Application for Patent claims priority to U.S. Patent Application No. 63/701,288 by Maroney et al., entitled “SECURITY FUNCTION MANAGEMENT WITHIN A MULTI-PORT MEMORY SYSTEM,” filed Sep. 30, 2024, which is assigned to the assignee hereof, and which is expressly incorporated by reference in its entirety herein.

### TECHNICAL FIELD

The following relates to one or more systems for memory, including security function management within a multi-port memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports security function management within a multi-port memory system in accordance with examples as disclosed herein.

FIG. 2 shows an example of an architecture that supports security function management within a multi-port memory system in accordance with examples as disclosed herein.

FIG. 3 shows an example of a system that supports security function management within a multi-port memory system in accordance with examples as disclosed herein.

FIG. 4 shows a block diagram of a memory system that supports security function management within a multi-port memory system in accordance with examples as disclosed herein.

FIG. 5 shows a block diagram of a host system that supports security function management within a multi-port memory system in accordance with examples as disclosed herein.

FIGS. 6 through 8 show flowcharts illustrating a method or methods that support security function management within a multi-port memory system in accordance with examples as disclosed herein.

### DETAILED DESCRIPTION

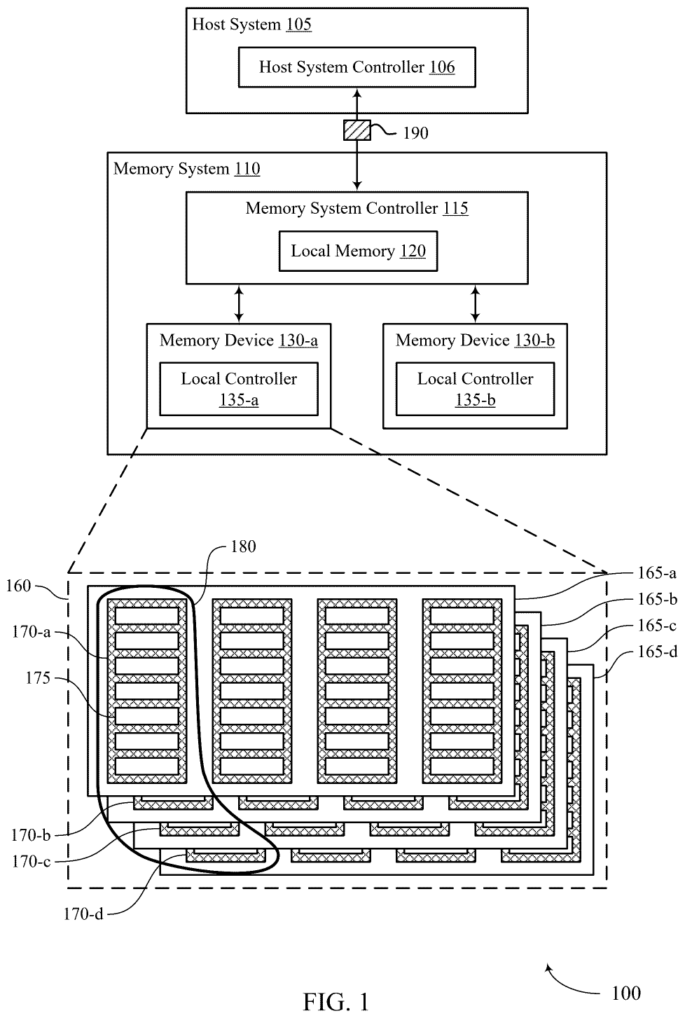

Some memory systems may include multiple ports (e.g., functions). Each port may include or otherwise be associated with or more resources or hardware components within the memory system (e.g., on a solid state device (SSD)). Some systems (e.g., automotive systems) may include a single memory system associated with (e.g., coupled with, in communication with) multiple host systems. For example, multiple host systems in a system may access a single multi-ported memory system (e.g., multi-ported SSD). In such an example, each port of the memory system may correspond to a respective physical connection with one or more external host systems. The host systems may communicate with the memory system via the one or more ports and corresponding interfaces to access data stored within the memory system. Definitions and procedures for securing input/output (I/O) communication via different ports in a multi-port memory system, as well as security measures for allowing host systems to access data stored within the memory system and methods to securely manage namespaces and trusted computing group (TCG) resources in a device, may be beneficial to improve security for multi-port memory systems. TCG, as described herein and with respect to FIG. 1-8, may refer to various TCG related technology (e.g., including TCG Opal security subsystem class and TCG Ruby SSC, among other examples).

Techniques described herein may support security function management by a trusted port and/or entity (e.g., management operating system) within a multi-port memory system. A memory system including multiple ports may receive a namespace configuration indicating an allocation of one or more logical block addresses (LBAs) to one or more of the ports. The memory system may receive one or more requests for access to one or more LBA ranges (e.g., via a request message, via an unlock command), and may perform an authorization procedure to authorize a single entity and/or corresponding port to provision and unlock one or more LBA ranges, including namespaces (e.g., defined LBA ranges), within the memory system. In some examples, the LBA ranges may be locked by default on bootup of the memory system. In some examples, host systems (e.g., virtual machines with guest operating systems) may request a management controller (e.g., virtual machine with a management operating system) to coordinate such authorization, or may request access to a memory system directly using one or more credentials and/or identifiers. Further, a management port may be indicated via one or more commands.

By using a single entity (e.g., a single trusted port) for security functions, a multi-ported system may have increased security and be less vulnerable to attacks than systems in which multiple ports and/or entities are able to manage access authorization and TCG resource management. Additionally, commands indicating a management port may allow a management port to be flexibly configured, allowing changing of the management port based on one or more factors (e.g., based on a module upgrade to a more secure host). Further, utilizing a single entity or port may be more space efficient than including multiple entities (e.g., including an entity per port, including a TCG master boot record (MBR) per port), thereby reducing firmware area. Using a single entity or port may also reduce overhead (e.g., reduce signaling and/or processing). In some examples, the memory system may represent an example of or otherwise be included within an automotive system (e.g., an automotive SSD) or another type of system associated with relatively high reliability and security requirements, and the techniques described herein for port resource management within a multi-port memory system may improve security and data integrity within the automotive system, thereby increasing user experience and mitigating risks from security attacks, among other examples. For example, one or more host systems (e.g., functions, applications, guest operating systems) within an automotive system may be less susceptible to attack or hacks than other host systems, and such host systems may be designated as the management host systems to be coupled with the management port(s) for managing other host system access, or may be enabled to request access to respective LBA ranges, or namespaces, which may improve security and reliability of the access authorization procedures and namespace resource management within the automotive system.

In addition to applicability in memory systems described herein, techniques for security function management within a multi-port memory system may be generally implemented to improve security and/or authentication features of various electronic devices and systems. As the use of electronic devices for handling private, user, or other sensitive information has become even more widespread, electronic devices and systems have become the target of increasingly frequent and sophisticated attacks. Further, unauthorized access or modification of data in security-critical devices such as vehicles, healthcare devices, and others may be especially concerning. Implementing the techniques described herein may improve the security of electronic devices and systems by using a single entity to provision and unlock LBA ranges, or namespaces, and enabling host systems to request access for respective LBA ranges, which may increase security of the device compared to other multi-port devices, among other benefits. Additionally, the memory system may be implemented within an automotive system (e.g., an automotive SSD), and may thereby support relatively increased security for the automotive system using the access authorization and namespace management techniques described herein.

Features of the disclosure are illustrated and described in the context of systems, devices, and circuits. Features of the disclosure are further illustrated and described in the context of architectures, systems, block diagrams, and flowcharts.

FIG. 1 shows an example of a system 100 that supports security function management within a multi-port memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., LBAs) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

In some examples, the system 100 may support security function management by a trusted port and/or entity (e.g., management operating system) within a multi-port memory system as described herein. For example, the memory system 110 may include multiple ports and may receive a namespace configuration 190 indicating an allocation of one or more LBAs (e.g., namespaces) to one or more of the ports. The memory system 110 may receive one or more requests for access to one or more LBA ranges (e.g., via a request message, via an unlock command), and may authorize such access by authorizing a single entity (e.g., single management operating system) and/or port to provision and unlock ranges of LBAs. In some examples, the host system 105 may be a management controller with a management operating system, and may transmit unlock commands to the memory system 110 to unlock LBA ranges for which other host systems 105 request access. Additionally, or alternatively, such additional host systems may transmit request messages directly to the memory system 110 (e.g., via a trusted management port). In some examples, such commands and messages may be received at the memory system 110 via a trusted management port that may be indicated via one or more other commands.

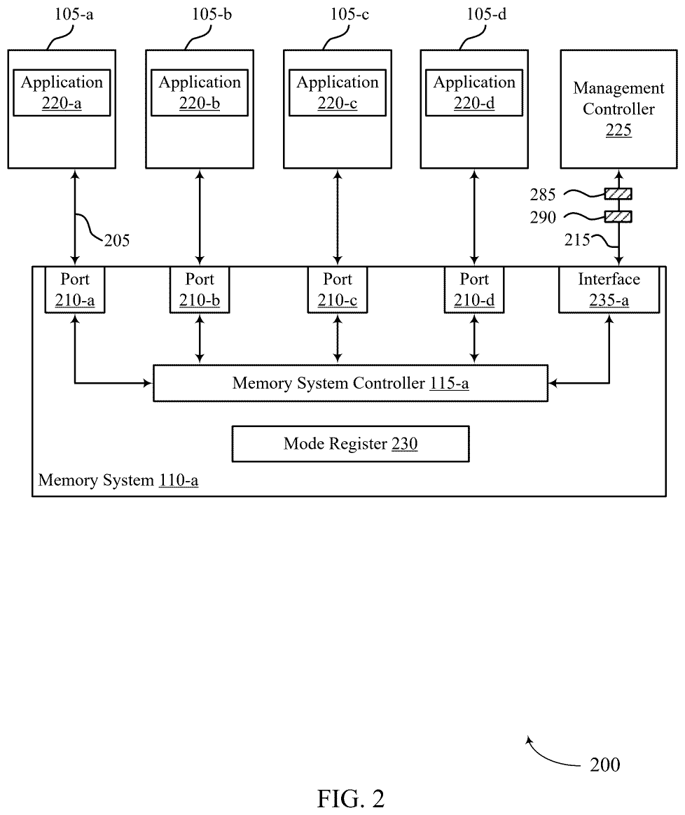

FIG. 2 shows an example of an architecture 200 that supports security function management within a multi-port memory system in accordance with examples as disclosed herein. One or more aspects of the architecture 200 may implement or may be implemented by one or more aspects of the system 100. For example, the architecture 200 may include a host system 105-a, a host system 105-b, a host system 105-c, a host system 105-d, and a memory system 110-a with a memory system controller 115-a and a mode register 230, which may be examples of corresponding devices or systems described herein. In some cases, the architecture 200 may be implemented in or as part of an automotive system, and architecture 200 may support increased security by selecting a security management entity and/or port.

For example, memory system 110-a may be a multi-ported memory system and may include a port 210-a, a port 210-b, a port 210-c, and a port 210-d. The ports 210 may allow for multiple host systems 105 to establish connections with the memory system 110-a and to execute commands using the memory system 110-a for executing applications 220 (e.g., or functions). For example, a host system 105-a may be coupled with the memory system 110-a via the port 210-a and may host (e.g., and may execute commands for) an application 220-a. A host system 105-b may be coupled with the memory system 110-a via the port 210-b and may host an application 220-b, a host system 105-c may be coupled with the memory system via the memory system 110-a via the port 210-c and may host an application 220-c, and a host system 105-d may be coupled with the memory system 110-a via the port 210-d and may host an application 220-d. In some examples, each port 210 may operate independently. For example, each port 210 may involve different link speeds (e.g., PCIe link speeds) or may be reset independently. Further, the ports 210 may operate simultaneously or concurrently, or at different times. In some cases, boot partitions, replay protected memory blocks (RPMBs), virtualization (e.g., single root I/O virtualization (SRIOV)), and resource allocation may also be per port.

Although the architecture 200 illustrates four host systems 105 and four ports 210, it is to be understood that a memory system may include any quantity and combination of ports and host systems, including four of each, or any other quantities. The memory system 110-a may include one or more memory arrays across one or more memory devices that store data for the execution of the various applications. The ports may provide an interface for communicating commands and data with the host systems 105, but the actual data for each host system 105 may be stored in various locations within the memory system 110-a.

In some examples, the host systems 105 may transmit commands (e.g., in-band commands) that are associated with execution of an application 220. The host systems 105 may be controlled by or may include one or more components or systems of an automotive platform, and applications 220 may support one or more functions of the automotive platform or some other type of platform. Such commands may be communicated to the memory system 110-a via a peripheral component interconnect (PCI) interface 205 between a host system 105 and a port 210 of the memory system 110-a, which may be referred to as an in-band channel. The host systems 105 may communicate with the memory system 110-a using the ports 210 via in-band signaling (e.g., via a PCIe bus) which may differ from out-of-band (OOB) signaling, as the PCI interface 205 may support transfer of data and commands, while one or more OOB channels may not be used for data transfer, but may instead be used for transfer of metadata and other management commands. Commands sent by a host system 105 may cause or instruct the memory system controller 115-a to execute operations and/or access memory (e.g., at one or more memory devices 130 of the memory system 110-a). The commands may be non-volatile memory express (NVMe) commands, or some other type of command.

In some examples, the memory system 110-a may include an interface 235-a (e.g., a management port) which may be used for managing one or more aspects of the memory system 110-a. In some examples, the memory system 110-a may use the interface 235-a for authentication of the host systems 105 prior to the memory system 110-a granting the host systems 105 access to the ports 210. For example, the memory system 110-a may grant a management controller 225 access to the interface 235-a based on an attestation process between the memory system 110-a and the authentication management controller 225. The authentication management controller 225 and the memory system 110-a may perform the attestation process by transmitting OOB signaling 215 via a system channel bus (e.g., an inter-integrated circuit (I2C) bus, a system management bus (SMBus)). Additionally, or alternatively, the OOB signaling 215 may be one or more vendor defined messages that are transmitted via an NVMe management interface (NVMe-MI), or some other interface. In some examples, the management controller 225 may be an example of a separate management controller with a separate management operating system, or may be an example of a combined host processor and management controller. If the management controller 225 is within a host system 105, the management controller 225 may communicate with the interface 235-a (e.g., a port) via an in-band interface, in some examples.

Once authenticated with the memory system 110-a, the management controller 225 may (e.g., via the OOB signaling 215) request that any one or more host systems 105 gain access (e.g., privileged access) to a respective port 210 of the memory system 110-a (or such ports may request to be a trusted port). For example, the authentication management controller 225 may transmit one or more commands that request that the host system 105-a gain privileged access to the port 210-a, that the host system 105-b gain privileged access to the port 210-b, and so on.

In accordance with examples described herein, the memory system 110-a may further increase security by determining a port as a main security aggregator and configurator. For example, the memory system 110-a may select a port, or function (e.g., a physical function), on a decentralized hub for the security infrastructure that manages security of other ports 210 based on attestation, where such a port may be configured as a namespace resource management port. In some examples, the memory system 110-a may support one or more TCG communication protocols that may define access authorization or namespace resource management, where the management port may be a TCG management port (TMP). In some examples, the memory system 110-a may be configured with a single trusted management port to prevent security breaches from other ports 210. For example, the memory system 110-a may receive a message 285 via a trusted interface or port (e.g., via the interface 235-a, via a trusted port 210) that may indicate the management port. Additionally, or alternatively, the interface 235-a may be the default trusted management port based on the interface 235-a being coupled with the management controller 225 via an OOB connection, or some other port may be a default. Further, the management controller 225, or a host system 105 acting as a management controller, may receive the message 285 to indicate the port. In some examples, if the trusted management port is the interface 235-a, the management controller 225 may run a corresponding TCG management application. In some cases, the memory system 110-a may include multiple security configurations per port 210.

Additionally, or alternatively, the memory system 110-a may select a single entity, such as the management controller 225 or a host system 105, to manage access authorization and namespace configurations for other host systems 105. For example, the memory system 110-a may receive a namespace configuration 290 from the management controller 225 indicating namespace allocations for each of the host systems 105 as well as credentials for access authorization, and may authorize one or more host systems 105 based on one or more commands and requests. In some cases, the management controller 225 may transmit the namespace configuration 290 in response to receiving the message 285 previously. In some cases, a virtual function of a host system 105 may request control of namespace resources (e.g., corresponding TCG resources) through a physical function of a host hypervisor management operating system, such as an operating system of the management controller 225. The management controller 225 may also configure a data structure, such as a virtual trusted peripheral (Tper) to maintain locking ranges and attributes, for locking corresponding LBA ranges. In another example, each of the host systems 105-a through 105-d with corresponding virtual functions may request access directly through a virtual Tper identifier (e.g., COMM-ID) type mechanism to request resource allocation from a main data object (e.g., main Tper).

In some examples, a single entity (e.g., TCG Management application of the management controller 225 or of another host system 105) may provision and unlock LBA ranges. Further, the methods described herein may refer to a single (physical) Tper model. For example, a single Tper model may involve Tper provisioning and/or configuration that may be permitted by a TCG management application (e.g., of the management controller 225) but not by other entities. Further, the host systems 105 (e.g., system on chip (SoC) and virtual machines (VMs), such as a virtual construct machine corresponding to a host system 105, or real-time operating systems (RTOSs)) that do not have access to the port (e.g., TMP) (e.g., the host systems 105-a through 105-d) may not be capable of discovering the TPer (e.g., discovering the Tper using interface (IF)-SEND/IF_RECV and defined protocol identifiers). In some examples, on power-on, a host with access to the TMP (e.g., the management controller 225) may be responsible for unlocking the namespaces and corresponding LBA ranges for each virtual function previously configured or provisioned by the TCG management application. Centralized unlocking of assigned or configured LBA range(s) of each virtual function and/or physical function may also allow each VM to read and write to one or more corresponding assigned virtual function allocated namespaces. Further, external operating systems (e.g., VMs or RTOSs) may not be required to support TCG, and the TMP may be permitted access to a shadow master boot record (MBR) table once TCG has been activated. In some examples, there may be no shadow MBR tables allocated or available to virtual functions and physical functions other than the TMP.

In some cases, by using a single entity (e.g., a single trusted port) for security functions, a multi-ported memory system 110-a may have increased security and be less vulnerable to attacks as compared to other multi-ported memory systems that allow access to namespaces by any host system coupled with any port 210. Additionally, or alternatively, the multi-ported memory system 110-a having the single trusted entity for security functions described herein may be as secure as or more secure than a single-port memory system with one device and one security namespace configuration (e.g., TCG configuration). Further, restricting to a single entity may simplify firmware and reduce memory system requirements of the memory system 110-a (e.g., requirements may include a single shadow MBR table, a single datastore table, a single admin security provider and locking security provider with associated tables). Indicating a TMP via a message 285 may also allow a management port to be flexibly configured, allowing changing of a management port based on one or more factors (e.g., based on a module upgrade to a more secure host).

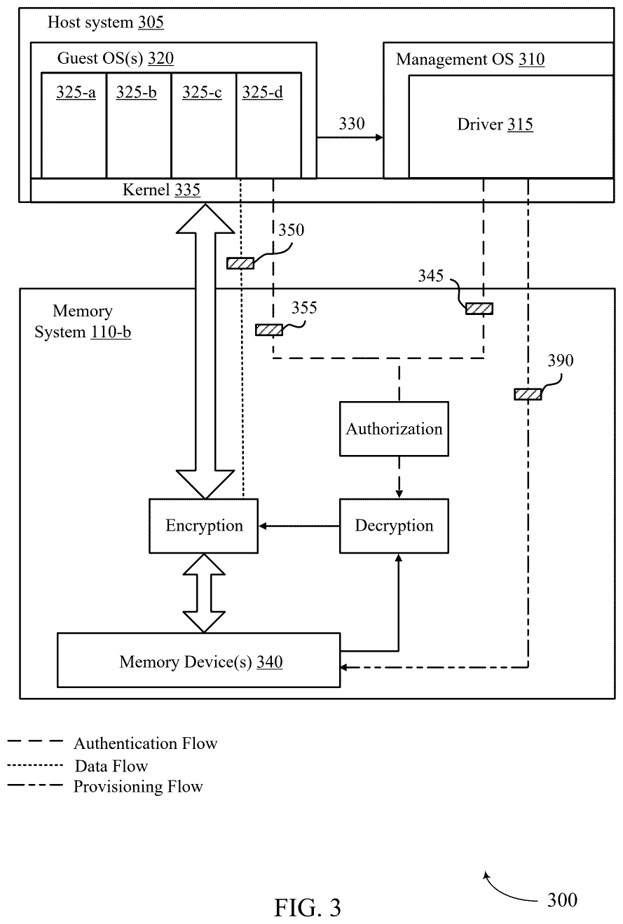

In some examples, the memory system 110-a may store data for applications associated with relatively high reliability and security requirements, such as a vehicle or other automated system. In such cases, the designation of a trusted management port and use of a single entity, as well as enabling host systems 105 to request access to corresponding LBA ranges, may reduce a likelihood of attacks or hacks to the system. For example, the trusted management port may be associated with a more secure connection than other ports and may thereby be less vulnerable to malicious actors, among other examples. Techniques for managing access authorization and namespace resource allocations via a single entity and management port are described in further detail elsewhere herein, including with reference to FIG. 3.

FIG. 3 shows an example of a system 300 that supports security function management within a multi-port memory system in accordance with examples as disclosed herein. One or more aspects of the system 300 may implement or may be implemented by one or more aspects of the system 100 and the architecture 200. For example, the system 300 may include a memory system 110-b that may be coupled with a host system 305 via one or more ports 210, where the host system 305 may include multiple host systems 105 (e.g., a multi-core host system) represented by corresponding guest operating systems 320. That is, a single SoC, for example, or other combined system, may include one or more separate hosts that execute separate functions and are associated with separate permissions for accessing the memory system 110-b. The memory system 110-b and the host system 305 including the guest operating systems 320 may represent examples of the memory systems 110 and 110-a and the host systems 105 described with respect to FIGS. 1 and 2. In some examples, the system 300 may support security function management as described herein.

For example, the host system 305 may include a single management operating system 310, which may include a corresponding physical function as well as a driver 315 (e.g., a parent partition platform manager micro controller unit (MCU) NVMe driver). The host system 305 may be a multi-core host including the one or more guest operating systems 320, each with a respective driver 325 (e.g., drivers 325-a, 325-b, 325-c, and 325-d corresponding to four guest operating systems 320). In some examples, the management operating system 310 and guest operating systems 320 may represent virtual machines. For example, the management operating system 310 may be an example of a virtual machine operating system of a virtual host system 105 or of a virtual management controller with a corresponding physical function. Each guest operating system 320 may be an example of a virtual machine operating system of a virtual host system 105 with one or more corresponding virtual functions, and may be located on a same system-on-chip (SoC) as the management operating system 310. The host system 305 may also be coupled with one or more servers, including a factory key management server (e.g., authentication key database with lock keys and passwords) via a network. Further, the host system 305 may be coupled with data center applications via the network. In some examples, the host system 305 may be an example of or may otherwise support an operating system within an automotive vehicle, such as a car, among other examples.

In some examples, a single entity (e.g., management operating system 310) may be used to increase security at the memory system 110-b. For example, the management operating system 310 may access the memory system 110-b (e.g., an SSD, one or more SSDs) through a corresponding physical function of the memory system 110-b. Further, vendor defined commands that are invoked by the host system 305 may be serviced by the corresponding physical function (e.g., virtual functions may not support communicating vendor defined commands). The management operating system 310 may further provide namespace provisioning (e.g., TCG provisioning) by managing ownership of provisioning, definition of locking ranges, unlocking LBA ranges, among other operations, through the physical function, as well as manage namespaces. The host system 305 may also include a kernel 335 (e.g., a hypervisor or container kernel) for communicating with the memory system 110-b. In some cases, the memory system 110-b may be a TCG secure encrypting drive (SED) supporting key encryption keys, media encryption keys, and key definition functions.

In a first example, a host system may perform an authorization process (e.g., one or more procedures to authorize itself) for security management of the memory system 110-b. For example, a host system, such as the management operating system 310, may be authorized during attestation after power on, along with a corresponding port coupled with the host system 105 and at the memory system 110-b (e.g., a TCG port). Namespace allocation and configuration may also be performed by the management operating system 310. For example, the memory system 110-b may receive, from the management operating system 310, a namespace configuration 390 that may be received successfully (e.g., not blocked or otherwise restricted) based on the authorization of the management operation system 310. In some examples, the namespace configuration 390 may indicate an allocation of one or more LBA ranges of the memory system 110-b to one or more ports, where each port may be coupled with a respective guest operating system 320 (e.g., a respective host system 105). For example, there may be one namespace per virtual function (e.g., a single Namespace Global Locking Object without Namespace Non-Global Range Locking Object support, where such features may relate to TCG).

In some cases, the memory system 110-b may be divided into user data space with multiple LBA locking ranges, where a locking region may be an LBA range within a total LBA range of a namespace that corresponds to a VM and virtual function (e.g., to a respective host system 105). For example, each VM may receive a locking range that is firewall protected from other VMs and locking ranges and may have a respective media encryption key. The locking range may be locked after power cycling, and such locking ranges may be indicated in the namespace configuration 390. In some examples, locking ranges may be independently cryptographically erased, where respective keys may be generated at time of range creation (e.g., at resource allocation). For example, the namespace configuration may also indicate one or more keys, passwords, and other credentials for each of the VMs and guest operating systems 320 (e.g., received from a factory key management server). In some cases, the memory system 110-b may store the namespace configuration, including keys and other credentials, for each operating system, to one or more memory devices 340. In some examples, an administrator (e.g., admin) may assign access to unlock ranges to zero or more users.

In some examples, the management operating system 310 may be an example of a single authority for the memory system 110-b. In some examples, authorities of the memory system 110-b may have different permissions, and may include admins that may set a security policy by configuring the access control settings (e.g., settings in a locking security provider) for one or more authorities (user and admin) as well as certain security policies. Authorities may also include users, which may have limited access and authority. For example, users may modify corresponding credentials (e.g., C_PIN credentials). Users may also perform actions delegated by admins (e.g., actions related to unlocking the memory system 110-b, such as a self-encrypting drive, on power-on). Admins may also modify access control settings, including modifying which guest operating systems 320 and VMs are allowed to unlock each of one or more LBA Ranges, and which entities may turn off one or more functions (e.g., turn off shadow MBR). In some cases, by modifying one or more settings, admins may grant permission to users to perform specific actions.

In the first example, each guest operating system 320 may be responsible for unlocking and accessing an associated LBA range (e.g., a corresponding locking region, an associated memory device) of the memory system 110-b. For example, each LBA range for each guest operating system 320 may be locked initially at the memory system 110-b. For example, the management operating system 310, before receiving based on a bootup procedure for the memory system 110-b, may transmit a command (e.g., a lock command) to the memory system 110-b to restrict access to the different LBA ranges allocated via the namespace configuration 390. In some cases, a guest operating system 320 may access one or more services or functionalities supported by an associated virtual function, and may be aware or able to access one or more locked LBA ranges at the locked memory system 110-b. In some examples, a guest operating system 320 may transmit a request to the management operating system 310, via a channel 330 (e.g., a virtual function to physical function API), to unlock one or more LBA ranges of the memory system 110-b. The channel 330 may thus enable one or more drivers 325 (e.g., virtual function drivers) to communicate with the driver 315 (e.g., a physical function driver) to request operations that may have a global effect (e.g., an effect across the memory system 110-b and/or host system 305) and may be used to communicate messages and generate interrupts.

The management operating system 310 may, in response to receiving a request, transmit an unlock command 345 to the memory system 110-b (e.g., via NVMe security send and NVMe receive for TCG protocol). One or more credentials and/or passwords may be used to unlock an LBA range of the memory system 110-b. In some examples, a trusted platform module (TPM), virtual TPM (vTPM), or other secure means may be used for securely storing the one or more credentials and/or passwords (e.g., credentials that the management operating system 310 provides to the memory system 110-b). In some cases, the memory system 110-b may perform an authorization process with the first guest operating system 320 to authorize the request based on matching a password received in the unlock command 345, and based on decrypting and matching credentials in the request to those stored from the namespace configuration 390.

Based on the authorization, the memory system 110-b may unlock the requested LBA range (e.g., locking region) to permit access to a corresponding guest operating system 320. For example, after the unlocking, the memory system 110-b may receive one or more access commands 350 for data stored within an LBA range of the unlocked locking region, and may freely access and communicate such data with the corresponding guest operating system 320. Further, an access command 350 received before a corresponding unlock command 345 may result in the memory system 110-b refraining from accessing data (as the locking region may still be locked). In some cases, each LBA range, or locking range, may be unlocked one at a time, or multiple LBA ranges may be unlocked at a time using similar procedures.

In a second example, on power-on, the management operating system 310 may be responsible for unlocking each LBA range for each guest operating system 320. For example, the unlock command 345 may be transmitted without a request from a guest operating system 320, where the management operating system 310 may retrieve corresponding credentials. In the second example, there may be one or more authorities to provide such access (e.g., one or more authorities per LBA range, per namespace, or per locking region). In some cases, there may be one namespace per virtual function (e.g., a single Namespace Global Locking Object+0 or more than 4 Namespace Non-Global Range Locking Object support, LBA range). In such an example, each guest operating system 320 may be aware of and able to access the memory system 110-b and associated regions, as such regions may be unlocked with respect to the guest operating system 320 (e.g., knowledge of TCG or associated access authorization and passwords may be transparent to guest operating systems 320). In some cases, portions of the memory system 110-b that are exposed to each guest operating system may be unlocked by the one or more authorities.

In a third example, one or more authorities, such as multiple management operating systems 310, may similarly be used for guest operating systems 320 that request unlocking of corresponding locking regions. In such an example, each guest operating system 320 may perceive one or more locked LBA ranges (e.g., may be aware or receiving indication of LBA ranges being locked), where locked LBA ranges may be unlocked by a guest operating system 320.

In a fourth example, each guest operating system 320 may be responsible for unlocking corresponding LBA ranges (e.g., namespaces, locking regions within namespaces) through a virtual Tper and identifier type mechanism. For example, a guest operating system 320 may transmit a request 355 to the memory system 110-b directly without intervention from the management operating system 310. In some cases, such transmission may be forward via the physical function and port of the management operating system 310 without the management operating system 310 generating a command. The request 355 may include a communication identifier (e.g., a COMM-ID) associated with the guest operating system 320, and the memory system 110-b may authorize the guest operating system 320 to access data in a corresponding namespace or locking region based on the request and the identifier. Further, a similar Tper may be utilized in the second and third examples. In some examples, there may be one Tper in the fourth example, with multiple admin authorities.

In some examples, an access operation, performed after authorization in any of the first example through the fourth example, may be a read. For example, the memory system 110-b may retrieve data corresponding to a requesting guest operating system 320, may decrypt the data based on authorization, and may transmit the data. Additionally, or alternatively, the access operation may be a write, and may include receiving the data via an access command 350, encrypting the data based at least in part on an encryption code and authorizing, and writing the data to a corresponding LBA range (e.g., namespace, locking range) based on encrypting the data.

In some examples, the access control described with respect to the first example through the fourth example, including permissions for VMs and virtual and physical functions, authorities, and whether guest operating systems 320 may request access through the management operating system 310 or directly, may be configured via one or more commands or messages. For example, such access control may be configured via the namespace configuration 390 or via another command received that configures one or more ports and that indicates a trusted management port. In another example, access control may be preconfigured at the memory system 110-b and the host system 305. Further, while the examples described herein involve one VM, virtual function, and guest operating system 320, any quantity of the operating system 320 may perform similar access requests and operations. Further, communications may be performed via a same physical port (e.g., a TCG management port). In some cases, a password (PSID) may be used to reset the memory system 110-b. Additionally, or alternatively, configurable namespace locking may allow assigning locking ranges to namespaces (e.g., to allow for one or more locking ranges per namespace each with individual access control and media encryption keys) and may be used dynamically with namespace management.

In some examples, utilizing the commands, authorization, and access procedures described with respect to FIG. 3 may thus support configuration of and use of a single entity and/or management port for resource management and for communication of additional commands. By using a single entity (e.g., a single trusted port) for security functions, the memory system 110-b may have increased security and be less vulnerable to attacks than systems in which multiple ports and/or entities are able to manage access authorization and TCG resource management. Additionally, commands indicating a management port may allow a management port to be flexibly configured, thereby supporting changing of the management port based on one or more factors (e.g., based on a module upgrade to a more secure host). Further, utilizing a single entity or port may be more space efficient than including multiple entities (e.g., including a TCG shadow MBR per port), thereby reducing firmware area. Using a single entity or port may also reduce overhead (e.g., reduce signaling and/or processing). Further, enabling individual host systems 105 (e.g., VMs including guest operating systems 320) to request access to respective LBA ranges, or namespaces, without knowledge of other LBA ranges may further increase security.

In some examples, the memory system 110-b may represent an example of or otherwise be included within an automotive system (e.g., an automotive SSD) or another type of system associated with relatively high reliability and security requirements, and the techniques described herein for access authorization and namespace resource management within a multi-port memory system may improve security and data integrity within the automotive system, thereby increasing user experience and mitigating risks from security attacks, among other examples. For example, one or more host systems 105 (e.g., a VM including the management operating system 310 and corresponding physical function) within an automotive system may be less susceptible to attack or hacks than other host systems 105. Such host systems 105 may be designated as the management host systems to be coupled with the management port(s) for managing other host system access (e.g., VMs including guest operating systems 320 and corresponding virtual functions), or the other host systems may be enabled to request access to LBA ranges, further improving security and reliability of the access authorization procedures and namespace resource management within the automotive system.

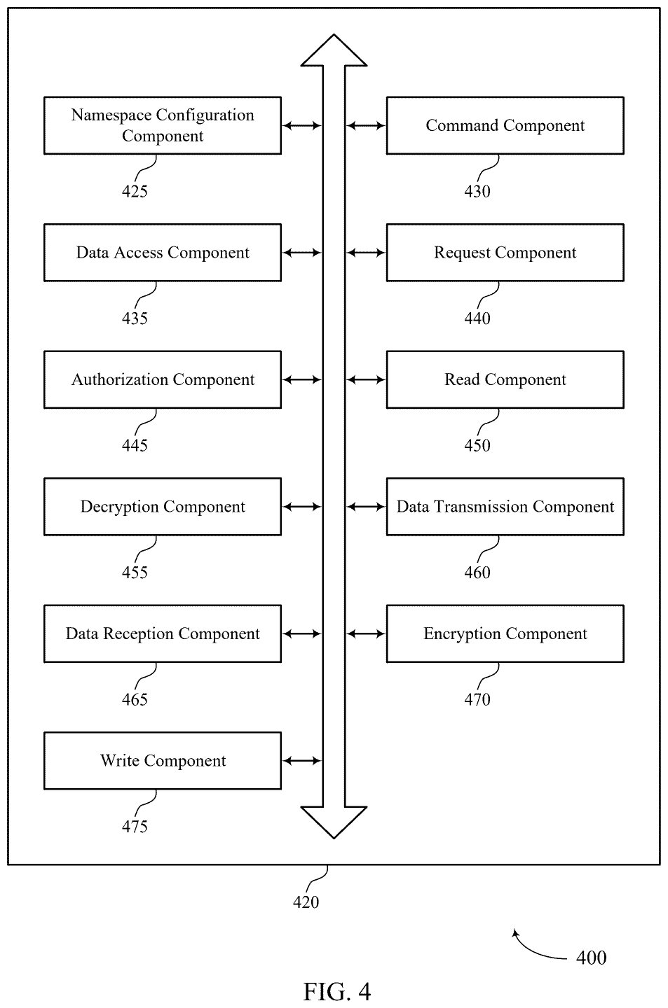

FIG. 4 shows a block diagram 400 of a memory system 420 that supports security function management within a multi-port memory system in accordance with examples as disclosed herein. The memory system 420 may be an example of aspects of a memory system as described with reference to FIGS. 1 through 3. The memory system 420, or various components thereof, may be an example of means for performing various aspects of security function management within a multi-port memory system as described herein. For example, the memory system 420 may include a namespace configuration component 425, a command component 430, a data access component 435, a request component 440, an authorization component 445, a read component 450, a decryption component 455, a data transmission component 460, a data reception component 465, an encryption component 470, a write component 475, or any combination thereof. Each of these components, or components of subcomponents thereof (e.g., one or more processors, one or more memories), may communicate, directly or indirectly, with one another (e.g., via one or more buses).

The namespace configuration component 425 may be configured as or otherwise support a means for receiving, from a management operating system, a namespace configuration that indicates an allocation of one or more logical address ranges of the memory system to one or more ports of a plurality of ports of the memory system, where each port of the plurality of ports is coupled with a respective host system of a plurality of host systems. The command component 430 may be configured as or otherwise support a means for receiving an unlock command that requests access, by at least a first host system of the plurality of host systems, to at least one logical address range of the one or more logical address ranges allocated via the namespace configuration. In some examples, the command component 430 may be configured as or otherwise support a means for receiving, from the first host system based at least in part on the unlock command, an access command for data stored within the at least one logical address range. The data access component 435 may be configured as or otherwise support a means for accessing the data stored within the at least one logical address range based at least in part on the access command.

In some examples, the unlock command requests access, by at least the first host system, to each of the one or more logical address ranges.

In some examples, to support receiving the unlock command, the command component 430 may be configured as or otherwise support a means for receiving the unlock command from the management operating system that is different from the first host system.

In some examples, to support receiving the unlock command, the command component 430 may be configured as or otherwise support a means for receiving the unlock command from the first host system. In some examples, to support receiving the unlock command, the authorization component 445 may be configured as or otherwise support a means for performing an authorization process with the first host system based at least in part on the unlock command, where accessing the data stored within the at least one logical address range is further based at least in part on the authorization process.

In some examples, the command component 430 may be configured as or otherwise support a means for receiving, based at least in part on the namespace configuration, a second unlock command that requests access, by at least a second host system of the plurality of host systems, to a second logical address range of the one or more logical address ranges allocated via the namespace configuration. In some examples, the command component 430 may be configured as or otherwise support a means for receiving, from the second host system based at least in part on the second unlock command, a second access command for second data stored within the second logical address range. In some examples, the data access component 435 may be configured as or otherwise support a means for accessing the second data stored within the second logical address range based at least in part on the second access command.

In some examples, the command component 430 may be configured as or otherwise support a means for receiving, from the management operating system before receiving the unlock command and based at least in part on a bootup procedure for the memory system, a lock command to restrict access, by the plurality of host systems, to the one or more logical address ranges allocated via the namespace configuration.

In some examples, the command component 430 may be configured as or otherwise support a means for receiving, from the first host system before receiving the unlock command, a second access command for the data stored within the at least one logical address range. In some examples, the data access component 435 may be configured as or otherwise support a means for refraining from accessing the data in response to the second access command based at least in part on the lock command.

In some examples, the memory system includes a plurality of namespaces, and each namespace of the plurality of namespaces includes a respective set of logical address ranges of the one or more logical address ranges.

In some examples, the namespace configuration component 425 may be configured as or otherwise support a means for receiving, from a management operating system, a namespace configuration that indicates an allocation of one or more logical address ranges of the memory system to one or more ports of a plurality of ports of the memory system, where each port of the plurality of ports is coupled with a respective host system of a plurality of host systems. The request component 440 may be configured as or otherwise support a means for receiving, from a first host system of the plurality of host systems based at least in part on the namespace configuration, a request to unlock a first logical address range, of the one or more logical address ranges, that includes data associated with the first host system, where the request includes a communication identifier associated with the first host system. The authorization component 445 may be configured as or otherwise support a means for authorizing, based at least in part on the request and the communication identifier of the first host system, the first host system to access the data within a first namespace including the first logical address range.

In some examples, the command component 430 may be configured as or otherwise support a means for receiving, from the first host system, an access command to access the data within the first namespace. In some examples, the data access component 435 may be configured as or otherwise support a means for accessing the data within the first namespace based at least in part on the request and authorizing the first host system to access the data.

In some examples, to support accessing the data, the read component 450 may be configured as or otherwise support a means for retrieving the data from the first namespace. In some examples, to support accessing the data, the decryption component 455 may be configured as or otherwise support a means for decrypting the data based at least in part on authorizing the first host system. In some examples, to support accessing the data, the data transmission component 460 may be configured as or otherwise support a means for transmitting the data to the first host system in response to the access command.

In some examples, to support accessing the data, the data reception component 465 may be configured as or otherwise support a means for receiving the data via the access command. In some examples, to support accessing the data, the encryption component 470 may be configured as or otherwise support a means for encrypting the data based at least in part on an encryption code and authorizing the first host system. In some examples, to support accessing the data, the write component 475 may be configured as or otherwise support a means for writing the data to the first namespace based at least in part on encrypting the data.

In some examples, the request component 440 may be configured as or otherwise support a means for receiving, from a second host system of the plurality of host systems, a second request to unlock a second logical address range, of the one or more logical address ranges, that includes second data associated with the second host system, where the request includes a second communication identifier associated with the second host system. In some examples, the authorization component 445 may be configured as or otherwise support a means for authorizing, based at least in part on the second request and the second communication identifier of the second host system, the second host system to access the second data within a second namespace including the second logical address range.

In some examples, the plurality of host systems includes a plurality of virtual machines each associated with one or more respective virtual functions for communicating with the memory system.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

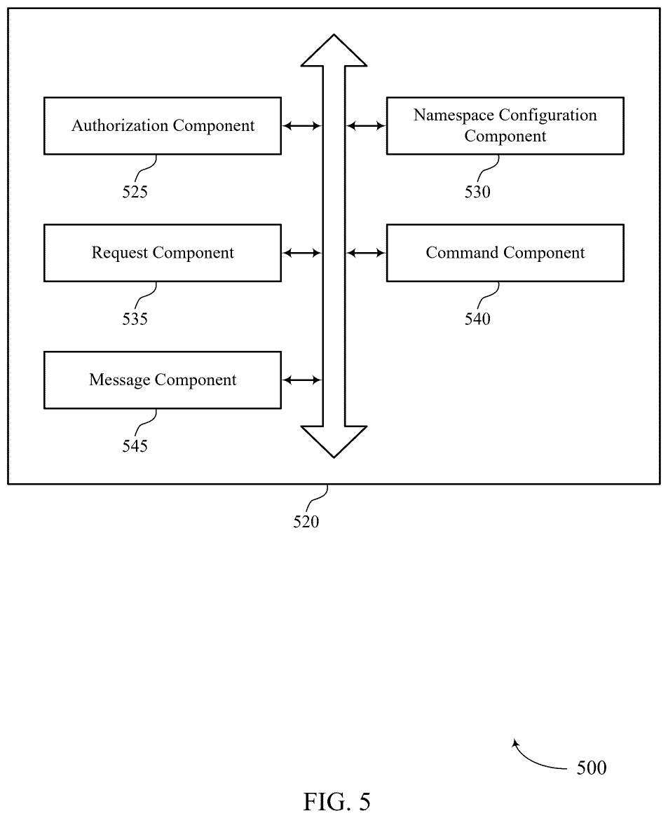

FIG. 5 shows a block diagram 500 of a host system 520 that supports security function management within a multi-port memory system in accordance with examples as disclosed herein. The host system 520 may be an example of aspects of a host system as described with reference to FIGS. 1 through 3. The host system 520, or various components thereof, may be an example of means for performing various aspects of security function management within a multi-port memory system as described herein. For example, the host system 520 may include an authorization component 525, a namespace configuration component 530, a request component 535, a command component 540, a message component 545, or any combination thereof. Each of these components, or components of subcomponents thereof (e.g., one or more processors, one or more memories), may communicate, directly or indirectly, with one another (e.g., via one or more buses).

The authorization component 525 may be configured as or otherwise support a means for performing an authorization process to authorize the first host system for security management of a memory system. The namespace configuration component 530 may be configured as or otherwise support a means for transmitting, based at least in part on the authorization process, a namespace configuration that indicates an allocation of a plurality of logical address ranges of the memory system to one or more ports of a plurality of ports of the memory system. The request component 535 may be configured as or otherwise support a means for receiving, from a second host system, a request to unlock one or more logical address ranges of the plurality of logical address ranges for access by the second host system. The command component 540 may be configured as or otherwise support a means for transmitting, to the memory system based at least in part on the request and the namespace configuration, a command to permit access, by the second host system, to the one or more logical address ranges.

In some examples, to support receiving the request, the request component 535 may be configured as or otherwise support a means for receiving the request via an application protocol interface between the first host system and a virtual function driver associated with the second host system, where the first host system is associated with a physical function for communicating with the memory system.

In some examples, the namespace configuration indicates a plurality of namespaces of the memory system, each namespace including one or more respective logical address ranges, and the namespace configuration allocates one or more namespaces of the plurality of namespaces to a respective host system of a plurality of host systems coupled with the memory system and in communication with the first host system.

In some examples, to support transmitting the command, the command component 540 may be configured as or otherwise support a means for transmitting the command including one or more security credentials associated with the second host system and the one or more logical address ranges.

In some examples, the message component 545 may be configured as or otherwise support a means for receiving a message that indicates the first host system is a trusted security management system, where transmitting the namespace configuration is based at least in part on the message.

In some examples, the first host system includes a first virtual machine, the second host system includes a second virtual machine, and the first virtual machine and the second virtual machine are located on a same system-on-chip.

In some examples, the described functionality of the host system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the host system 520, or various components thereof, may be implemented at least in part by instructions (e.g., stored in memory, non-transitory computer-readable medium) executable by such at least one processor.

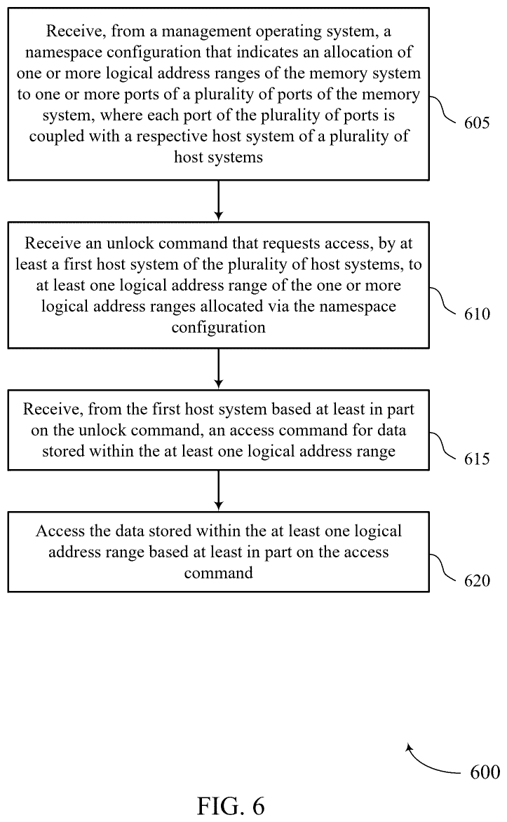

FIG. 6 shows a flowchart illustrating a method 600 that supports security function management within a multi-port memory system in accordance with examples as disclosed herein. The operations of method 600 may be implemented by a memory system or its components as described herein. For example, the operations of method 600 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 605, the method may include receiving, from a management operating system, a namespace configuration that indicates an allocation of one or more logical address ranges of the memory system to one or more ports of a plurality of ports of the memory system, where each port of the plurality of ports is coupled with a respective host system of a plurality of host systems. In some examples, aspects of the operations of 605 may be performed by a namespace configuration component 425 as described with reference to FIG. 4.

At 610, the method may include receiving an unlock command that requests access, by at least a first host system of the plurality of host systems, to at least one logical address range of the one or more logical address ranges allocated via the namespace configuration. In some examples, aspects of the operations of 610 may be performed by a command component 430 as described with reference to FIG. 4.

At 615, the method may include receiving, from the first host system based at least in part on the unlock command, an access command for data stored within the at least one logical address range. In some examples, aspects of the operations of 615 may be performed by a command component 430 as described with reference to FIG. 4.

At 620, the method may include accessing the data stored within the at least one logical address range based at least in part on the access command. In some examples, aspects of the operations of 620 may be performed by a data access component 435 as described with reference to FIG. 4.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving, from a management operating system, a namespace configuration that indicates an allocation of one or more logical address ranges of the memory system to one or more ports of a plurality of ports of the memory system, where each port of the plurality of ports is coupled with a respective host system of a plurality of host systems; receiving an unlock command that requests access, by at least a first host system of the plurality of host systems, to at least one logical address range of the one or more logical address ranges allocated via the namespace configuration; receiving, from the first host system based at least in part on the unlock command, an access command for data stored within the at least one logical address range; and accessing the data stored within the at least one logical address range based at least in part on the access command.

Aspect 2: The method, apparatus, or non-transitory computer-readable medium of aspect 1, where the unlock command requests access, by at least the first host system, to each of the one or more logical address ranges.

Aspect 3: The method, apparatus, or non-transitory computer-readable medium of any of aspects 1 through 2, where receiving the unlock command includes operations, features, circuitry, logic, means, or instructions, or any combination thereof for receiving the unlock command from the management operating system that is different from the first host system.

Aspect 4: The method, apparatus, or non-transitory computer-readable medium of any of aspects 1 through 3, where receiving the unlock command includes operations, features, circuitry, logic, means, or instructions, or any combination thereof for receiving the unlock command from the first host system, the method further including performing an authorization process with the first host system based at least in part on the unlock command, where accessing the data stored within the at least one logical address range is further based at least in part on the authorization process.

Aspect 5: The method, apparatus, or non-transitory computer-readable medium of any of aspects 1 through 4, further including operations, features, circuitry, logic, means, or instructions, or any combination thereof for receiving, based at least in part on the namespace configuration, a second unlock command that requests access, by at least a second host system of the plurality of host systems, to a second logical address range of the one or more logical address ranges allocated via the namespace configuration; receiving, from the second host system based at least in part on the second unlock command, a second access command for second data stored within the second logical address range; and accessing the second data stored within the second logical address range based at least in part on the second access command.

Aspect 6: The method, apparatus, or non-transitory computer-readable medium of any of aspects 1 through 5, further including operations, features, circuitry, logic, means, or instructions, or any combination thereof for receiving, from the management operating system before receiving the unlock command and based at least in part on a bootup procedure for the memory system, a lock command to restrict access, by the plurality of host systems, to the one or more logical address ranges allocated via the namespace configuration.

Aspect 7: The method, apparatus, or non-transitory computer-readable medium of aspect 6, further including operations, features, circuitry, logic, means, or instructions, or any combination thereof for receiving, from the first host system before receiving the unlock command, a second access command for the data stored within the at least one logical address range and refraining from accessing the data in response to the second access command based at least in part on the lock command.

Aspect 8: The method, apparatus, or non-transitory computer-readable medium of any of aspects 6 through 7, where: the memory system includes a plurality of namespaces; and each namespace of the plurality of namespaces includes a respective set of logical address ranges of the one or more logical address ranges.

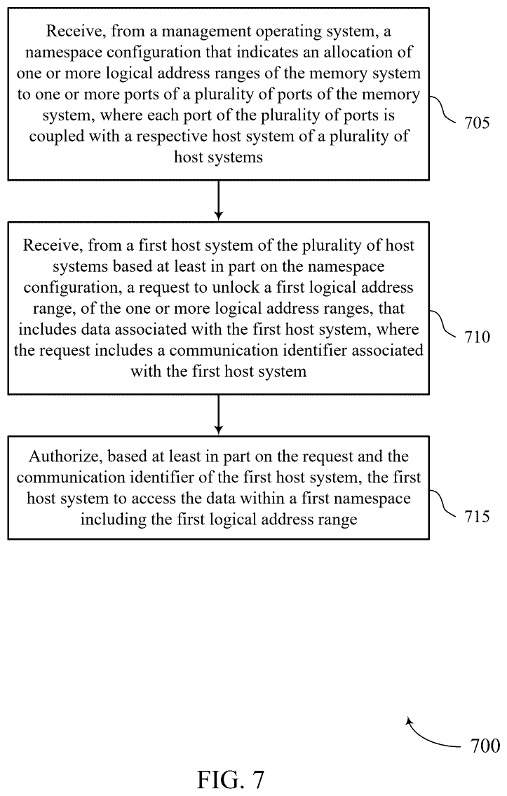

FIG. 7 shows a flowchart illustrating a method 700 that supports security function management within a multi-port memory system in accordance with examples as disclosed herein. The operations of method 700 may be implemented by a memory system or its components as described herein. For example, the operations of method 700 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 705, the method may include receiving, from a management operating system, a namespace configuration that indicates an allocation of one or more logical address ranges of the memory system to one or more ports of a plurality of ports of the memory system, where each port of the plurality of ports is coupled with a respective host system of a plurality of host systems. In some examples, aspects of the operations of 705 may be performed by a namespace configuration component 425 as described with reference to FIG. 4.

At 710, the method may include receiving, from a first host system of the plurality of host systems based at least in part on the namespace configuration, a request to unlock a first logical address range, of the one or more logical address ranges, that includes data associated with the first host system, where the request includes a communication identifier associated with the first host system. In some examples, aspects of the operations of 710 may be performed by a request component 440 as described with reference to FIG. 4.

At 715, the method may include authorizing, based at least in part on the request and the communication identifier of the first host system, the first host system to access the data within a first namespace including the first logical address range. In some examples, aspects of the operations of 715 may be performed by an authorization component 445 as described with reference to FIG. 4.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

Aspect 9: A method, apparatus, or non-transitory computer-readable medium including operations, features, circuitry, logic, means, or instructions, or any combination thereof for receiving, from a management operating system, a namespace configuration that indicates an allocation of one or more logical address ranges of the memory system to one or more ports of a plurality of ports of the memory system, where each port of the plurality of ports is coupled with a respective host system of a plurality of host systems; receiving, from a first host system of the plurality of host systems based at least in part on the namespace configuration, a request to unlock a first logical address range, of the one or more logical address ranges, that includes data associated with the first host system, where the request includes a communication identifier associated with the first host system; and authorizing, based at least in part on the request and the communication identifier of the first host system, the first host system to access the data within a first namespace including the first logical address range.

Aspect 10: The method, apparatus, or non-transitory computer-readable medium of aspect 9, further including operations, features, circuitry, logic, means, or instructions, or any combination thereof for receiving, from the first host system, an access command to access the data within the first namespace and accessing the data within the first namespace based at least in part on the request and authorizing the first host system to access the data.

Aspect 11: The method, apparatus, or non-transitory computer-readable medium of aspect 10, where accessing the data includes operations, features, circuitry, logic, means, or instructions, or any combination thereof for retrieving the data from the first namespace, the method further including: decrypting the data based at least in part on authorizing the first host system; and transmitting the data to the first host system in response to the access command.

Aspect 12: The method, apparatus, or non-transitory computer-readable medium of any of aspects 10 through 11, where accessing the data includes operations, features, circuitry, logic, means, or instructions, or any combination thereof for receiving the data via the access command, the method further including: encrypting the data based at least in part on an encryption code and authorizing the first host system; and writing the data to the first namespace based at least in part on encrypting the data.

Aspect 13: The method, apparatus, or non-transitory computer-readable medium of any of aspects 9 through 12, further including operations, features, circuitry, logic, means, or instructions, or any combination thereof for receiving, from a second host system of the plurality of host systems, a second request to unlock a second logical address range, of the one or more logical address ranges, that includes second data associated with the second host system, where the request includes a second communication identifier associated with the second host system and authorizing, based at least in part on the second request and the second communication identifier of the second host system, the second host system to access the second data within a second namespace including the second logical address range.

Aspect 14: The method, apparatus, or non-transitory computer-readable medium of any of aspects 9 through 13, where the plurality of host systems includes a plurality of virtual machines each associated with one or more respective virtual functions for communicating with the memory system.

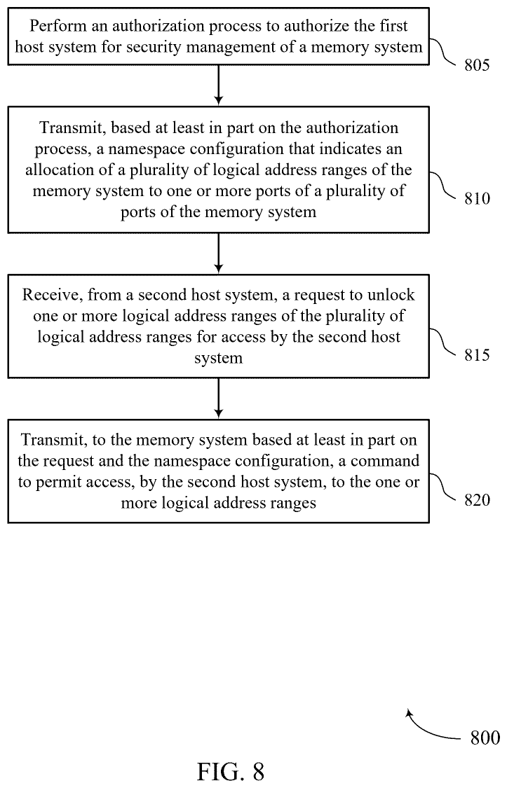

FIG. 8 shows a flowchart illustrating a method 800 that supports security function management within a multi-port memory system in accordance with examples as disclosed herein. The operations of method 800 may be implemented by a host system or its components as described herein. For example, the operations of method 800 may be performed by a host system as described with reference to FIGS. 1 through 3 and 5. In some examples, a host system may execute a set of instructions to control the functional elements of the device to perform the described functions. Additionally, or alternatively, the host system may perform aspects of the described functions using special-purpose hardware.

At 805, the method may include performing an authorization process to authorize the first host system for security management of a memory system. In some examples, aspects of the operations of 805 may be performed by an authorization component 525 as described with reference to FIG. 5.

At 810, the method may include transmitting, based at least in part on the authorization process, a namespace configuration that indicates an allocation of a plurality of logical address ranges of the memory system to one or more ports of a plurality of ports of the memory system. In some examples, aspects of the operations of 810 may be performed by a namespace configuration component 530 as described with reference to FIG. 5.

At 815, the method may include receiving, from a second host system, a request to unlock one or more logical address ranges of the plurality of logical address ranges for access by the second host system. In some examples, aspects of the operations of 815 may be performed by a request component 535 as described with reference to FIG. 5.

At 820, the method may include transmitting, to the memory system based at least in part on the request and the namespace configuration, a command to permit access, by the second host system, to the one or more logical address ranges. In some examples, aspects of the operations of 820 may be performed by a command component 540 as described with reference to FIG. 5.

In some examples, an apparatus as described herein may perform a method or methods, such as the method 800. The apparatus may include features, circuitry, logic, means, or instructions (e.g., a non-transitory computer-readable medium storing instructions executable by a processor), or any combination thereof for performing the following aspects of the present disclosure:

Aspect 15: A method, apparatus, or non-transitory computer-readable medium including operations, features, circuitry, logic, means, or instructions, or any combination thereof for performing an authorization process to authorize the first host system for security management of a memory system; transmitting, based at least in part on the authorization process, a namespace configuration that indicates an allocation of a plurality of logical address ranges of the memory system to one or more ports of a plurality of ports of the memory system; receiving, from a second host system, a request to unlock one or more logical address ranges of the plurality of logical address ranges for access by the second host system; and transmitting, to the memory system based at least in part on the request and the namespace configuration, a command to permit access, by the second host system, to the one or more logical address ranges.

Aspect 16: The method, apparatus, or non-transitory computer-readable medium of aspect 15, where receiving the request includes operations, features, circuitry, logic, means, or instructions, or any combination thereof for receiving the request via an application protocol interface between the first host system and a virtual function driver associated with the second host system, where the first host system is associated with a physical function for communicating with the memory system.

Aspect 17: The method, apparatus, or non-transitory computer-readable medium of any of aspects 15 through 16, where: the namespace configuration indicates a plurality of namespaces of the memory system, each namespace including one or more respective logical address ranges; and the namespace configuration allocates one or more namespaces of the plurality of namespaces to a respective host system of a plurality of host systems coupled with the memory system and in communication with the first host system.

Aspect 18: The method, apparatus, or non-transitory computer-readable medium of any of aspects 15 through 17, where transmitting the command includes operations, features, circuitry, logic, means, or instructions, or any combination thereof for transmitting the command including one or more security credentials associated with the second host system and the one or more logical address ranges.

Aspect 19: The method, apparatus, or non-transitory computer-readable medium of any of aspects 15 through 18, further including operations, features, circuitry, logic, means, or instructions, or any combination thereof for receiving a message that indicates the first host system is a trusted security management system, where transmitting the namespace configuration is based at least in part on the message.

Aspect 20: The method, apparatus, or non-transitory computer-readable medium of any of aspects 15 through 19, where: the first host system includes a first virtual machine; the second host system includes a second virtual machine; and the first virtual machine and the second virtual machine are located on a same system-on-chip.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples. ” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components. ” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive, from a management operating system, a namespace configuration that indicates an allocation of one or more logical address ranges of the memory system to one or more ports of a plurality of ports of the memory system, wherein each port of the plurality of ports is coupled with a respective host system of a plurality of host systems;
receive an unlock command that requests access, by at least a first host system of the plurality of host systems, to at least one logical address range of the one or more logical address ranges allocated via the namespace configuration;
receive, from the first host system based at least in part on the unlock command, an access command for data stored within the at least one logical address range; and
access the data stored within the at least one logical address range based at least in part on the access command.

2. The memory system of claim 1, wherein the unlock command requests access, by at least the first host system, to each of the one or more logical address ranges.

3. The memory system of claim 1, wherein receiving the unlock command comprises the processing circuitry configured to cause the memory system to:
receive the unlock command from the management operating system that is different from the first host system.

4. The memory system of claim 1, wherein receiving the unlock command comprises the processing circuitry configured to cause the memory system to:
receive the unlock command from the first host system, wherein the processing circuitry is further configured to cause the memory system to:
perform an authorization process with the first host system based at least in part on the unlock command, wherein accessing the data stored within the at least one logical address range is further based at least in part on the authorization process.

5. The memory system of claim 1, wherein the processing circuitry is further configured to cause the memory system to:
receive, based at least in part on the namespace configuration, a second unlock command that requests access, by at least a second host system of the plurality of host systems, to a second logical address range of the one or more logical address ranges allocated via the namespace configuration;
receive, from the second host system based at least in part on the second unlock command, a second access command for second data stored within the second logical address range; and
access the second data stored within the second logical address range based at least in part on the second access command.

6. The memory system of claim 1, wherein the processing circuitry is further configured to cause the memory system to:
receive, from the management operating system before receiving the unlock command and based at least in part on a bootup procedure for the memory system, a lock command to restrict access, by the plurality of host systems, to the one or more logical address ranges allocated via the namespace configuration.

7. The memory system of claim 6, wherein the processing circuitry is further configured to cause the memory system to:
receive, from the first host system before receiving the unlock command, a second access command for the data stored within the at least one logical address range; and
refrain from accessing the data in response to the second access command based at least in part on the lock command.

8. The memory system of claim 6, wherein:
the memory system comprises a plurality of namespaces; and
each namespace of the plurality of namespaces comprises a respective set of logical address ranges of the one or more logical address ranges.

9. A memory system, comprising:
one or more memory devices; and
processing circuitry coupled with the one or more memory devices and configured to cause the memory system to:
receive, from a management operating system, a namespace configuration that indicates an allocation of one or more logical address ranges of the memory system to one or more ports of a plurality of ports of the memory system, wherein each port of the plurality of ports is coupled with a respective host system of a plurality of host systems;
receive, from a first host system of the plurality of host systems based at least in part on the namespace configuration, a request to unlock a first logical address range, of the one or more logical address ranges, that comprises data associated with the first host system, wherein the request comprises a communication identifier associated with the first host system; and
authorize, based at least in part on the request and the communication identifier of the first host system, the first host system to access the data within a first namespace comprising the first logical address range.

10. The memory system of claim 9, wherein the processing circuitry is further configured to cause the memory system to:
receive, from the first host system, an access command to access the data within the first namespace; and
access the data within the first namespace based at least in part on the request and authorizing the first host system to access the data.

11. The memory system of claim 10, wherein accessing the data comprises the processing circuitry configured to cause the memory system to:
retrieve the data from the first namespace, wherein the processing circuitry is further configured to cause the memory system to:
decrypt the data based at least in part on authorizing the first host system; and
transmit the data to the first host system in response to the access command.

12. The memory system of claim 10, wherein accessing the data comprises the processing circuitry configured to cause the memory system to:
receive the data via the access command, wherein the processing circuitry is further configured to cause the memory system to:
encrypt the data based at least in part on an encryption code and authorizing the first host system; and
write the data to the first namespace based at least in part on encrypting the data.

13. The memory system of claim 9, wherein the processing circuitry is further configured to cause the memory system to:
receive, from a second host system of the plurality of host systems, a second request to unlock a second logical address range, of the one or more logical address ranges, that comprises second data associated with the second host system, wherein the request comprises a second communication identifier associated with the second host system; and
authorize, based at least in part on the second request and the second communication identifier of the second host system, the second host system to access the second data within a second namespace comprising the second logical address range.

14. The memory system of claim 9, wherein the plurality of host systems comprises a plurality of virtual machines each associated with one or more respective virtual functions for communicating with the memory system.

15. A first host system, comprising:
processing circuitry associated with one or more memory devices and configured to cause the first host system to:
perform an authorization process to authorize the first host system for security management of a memory system;
transmit, based at least in part on the authorization process, a namespace configuration that indicates an allocation of a plurality of logical address ranges of the memory system to one or more ports of a plurality of ports of the memory system;
receive, from a second host system, a request to unlock one or more logical address ranges of the plurality of logical address ranges for access by the second host system; and
transmit, to the memory system based at least in part on the request and the namespace configuration, a command to permit access, by the second host system, to the one or more logical address ranges.

16. The first host system of claim 15, wherein receiving the request comprises the processing circuitry configured to cause the first host system to:
receive the request via an application protocol interface between the first host system and a virtual function driver associated with the second host system, wherein the first host system is associated with a physical function for communicating with the memory system.

17. The first host system of claim 15, wherein:
the namespace configuration indicates a plurality of namespaces of the memory system, each namespace including one or more respective logical address ranges; and
the namespace configuration allocates one or more namespaces of the plurality of namespaces to a respective host system of a plurality of host systems coupled with the memory system and in communication with the first host system.

18. The first host system of claim 15, wherein transmitting the command comprises the processing circuitry configured to cause the first host system to:
transmit the command comprising one or more security credentials associated with the second host system and the one or more logical address ranges.

19. The first host system of claim 15, wherein the processing circuitry is further configured to cause the first host system to:
receive a message that indicates the first host system is a trusted security management system, wherein transmitting the namespace configuration is based at least in part on the message.

20. The first host system of claim 15, wherein:
the first host system comprises a first virtual machine;
the second host system comprises a second virtual machine; and
the first virtual machine and the second virtual machine are located on a same system-on-chip.

21. A method by a memory system, comprising:
receiving, from a management operating system, a namespace configuration that indicates an allocation of one or more logical address ranges of the memory system to one or more ports of a plurality of ports of the memory system, wherein each port of the plurality of ports is coupled with a respective host system of a plurality of host systems;
receiving an unlock command that requests access, by at least a first host system of the plurality of host systems, to at least one logical address range of the one or more logical address ranges allocated via the namespace configuration;
receiving, from the first host system based at least in part on the unlock command, an access command for data stored within the at least one logical address range; and
accessing the data stored within the at least one logical address range based at least in part on the access command.

22. The method of claim 21, wherein the unlock command requests access, by at least the first host system, to each of the one or more logical address ranges.

23. The method of claim 21, wherein receiving the unlock command comprises:
receiving the unlock command from the management operating system that is different from the first host system.

24. The method of claim 21, wherein receiving the unlock command comprises:
receiving the unlock command from the first host system, and wherein the method further comprises:
performing an authorization process with the first host system based at least in part on the unlock command, wherein accessing the data stored within the at least one logical address range is further based at least in part on the authorization process.

25. The method of claim 21, wherein receiving the unlock command comprises:
receiving, based at least in part on the namespace configuration, a second unlock command that requests access, by at least a second host system of the plurality of host systems, to a second logical address range of the one or more logical address ranges allocated via the namespace configuration;
receiving, from the second host system based at least in part on the second unlock command, a second access command for second data stored within the second logical address range; and
accessing the second data stored within the second logical address range based at least in part on the second access command.

26. The method of claim 21, further comprising:
receiving, from the management operating system before receiving the unlock command and based at least in part on a bootup procedure for the memory system, a lock command to restrict access, by the plurality of host systems, to the one or more logical address ranges allocated via the namespace configuration.

27. A method by a memory system, comprising:
receiving, from a management operating system, a namespace configuration that indicates an allocation of one or more logical address ranges of the memory system to one or more ports of a plurality of ports of the memory system, wherein each port of the plurality of ports is coupled with a respective host system of a plurality of host systems;
receiving, from a first host system of the plurality of host systems based at least in part on the namespace configuration, a request to unlock a first logical address range, of the one or more logical address ranges, that comprises data associated with the first host system, wherein the request comprises a communication identifier associated with the first host system; and
authorizing, based at least in part on the request and the communication identifier of the first host system, the first host system to access the data within a first namespace comprising the first logical address range.

28. The method of claim 27, further comprising:
receiving, from the first host system, an access command to access the data within the first namespace; and
accessing the data within the first namespace based at least in part on the request and authorizing the first host system to access the data.

29. The method of claim 28, wherein accessing the data comprises:
retrieving the data from the first namespace, the method further comprising:
decrypting the data based at least in part on authorizing the first host system; and
transmitting the data to the first host system in response to the access command.

30. The method of claim 28, wherein accessing the data comprises:
receiving the data via the access command, the method further comprising:
encrypting the data based at least in part on an encryption code and authorizing the first host system; and
writing the data to the first namespace based at least in part on encrypting the data.
